(19) United States
(12) Patent Application Publication
(10) Pub. No.: US 2005/0051542 A1
(43) Pub. Date: Mar. 10, 2005

(54) Microwave meat cooker

(76) Inventor: Eugene Kyle Boyd, Fort Worth, TX (US)

Correspondence Address: Eugene K. Boyd, 7821 Corina Dr., Fort Worth, TX, 76108, US

(21) Appl. No.: 10/419,295

(22) Filed: Sep. 4, 2003

(51) Int. Cl. H05B 6/80

(52) U.S. Cl. 219/735; 219/725

(57) ABSTRACT

FIG. 1 shows the lid. #2 are the vents. FIG. 2 is the level, which sits inside the cookware shown in FIG. 3 #5. #3 being the level, #4 is the lifting pin, shown in FIG. 2. #5 is the cooking container shown in FIG. 3. #6 are the level supports for the level (s) in FIG. 2. #7 are the vent, shown in FIG. 3. All parts shown in FIGS. 1, 2 and 3 are made of supports tempered plastic. Also note this cookware is for microwave only. There are a total of four parts for this cookware. One lid, shown in FIG. 1. Two levels, shown in FIG. 2. one container as seen in FIG. 3. The vents shown in FIGS. 1 and 3 prevent pressure build up during the cooking or micro waving process.

This invention deals with the ability to cook raw meats in a utility designed for the microwave. The Microwave Meat Cooker has the capability of cooking up to ten pieces of raw meat in a very short time. You can cook various types of meat in the cooker such as chicken, pork chops, steaks, and various other meats. With this new utility you can cook a faster meal, without the use of cooking oil, and still have a moist, tasty, and freshly cooked steak or steaks. Cooking oils and other substances that are used to keep meats moist are not needed because the meat is cooked in its own juices and less moisture is lost. This utility also can be considered a dietary tool for those seeking a healthier way of eating.

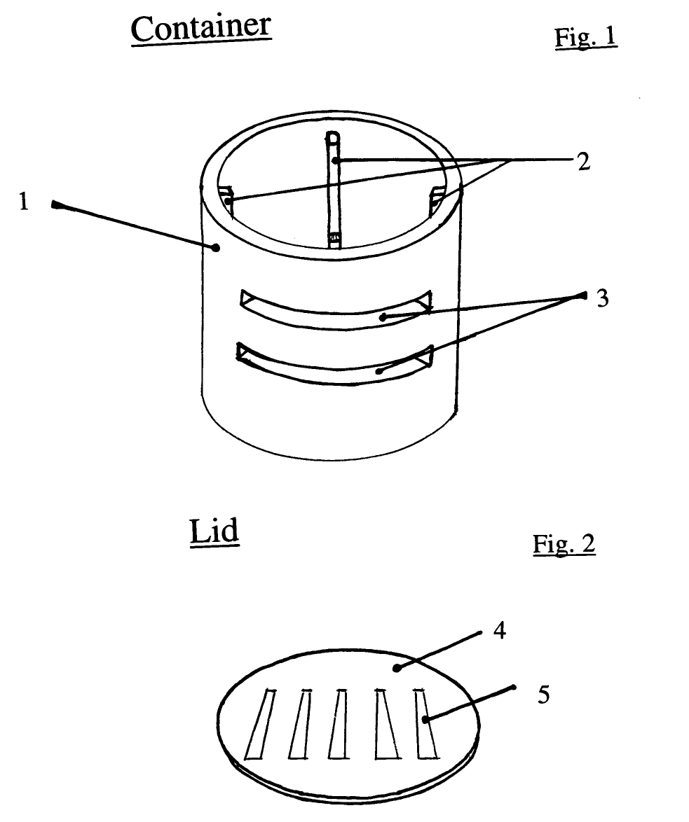

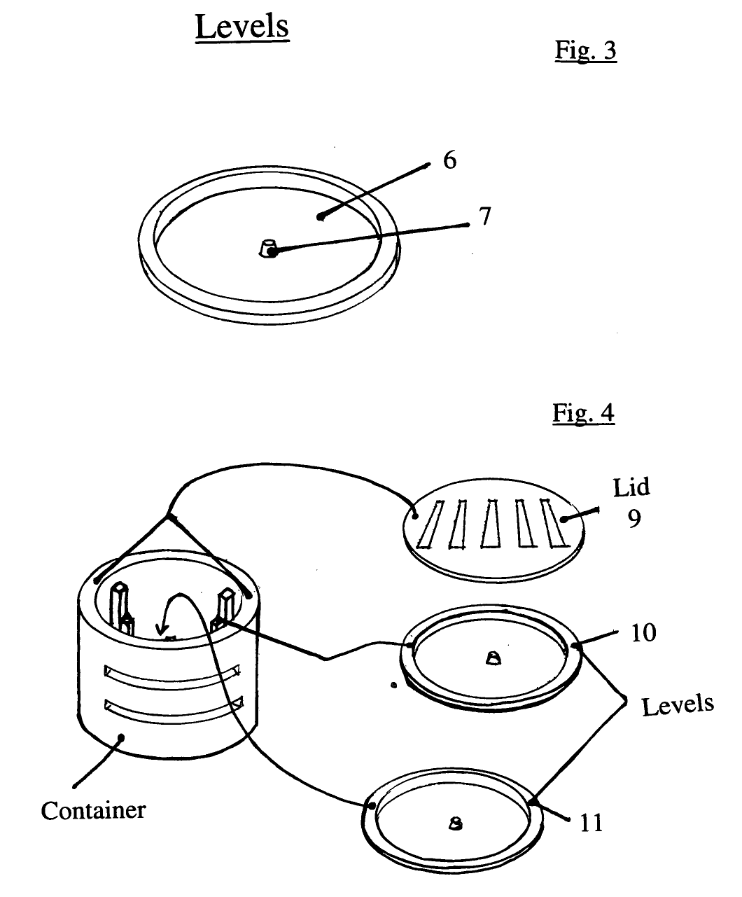

The design FIG. 4 just has four simple parts. First piece FIG. 1 is the container. It has three level supports (2) that run down the inner sides. To prevent pressure build up, there are three sets of vents (3) around the sides of the container. The second part FIG. 2-4 is the lid. It also has vents (5). The last two pieces which sit inside the container, FIG. 1, on the level supports (2) are the levels, FIG. 3. One level will have a smaller diameter. Each level has a lifting pin (7).

1 Cookware

2 Level Supports

3 Vents

4 Lid

5 Vents

6 Level

7 Lifting Pin

The Microwave Meat Cooker is a simple utility to use. It doesn't require a whole lot of effort. The steps are simple, first take the pieces of meat that you want to cook and place them in the cookware, FIG. 1. If you don't have enough room on the bottom of the cookware (1) then you'll have the other levels (6) to place meat or meats. After the meats have been placed, put the vented lid (4) on as shown in FIG. 4. Place the Microwave Meat Cooker in the microwave, set the time and that's it. In a few minutes you'll have a moist, tasty and freshly cooked steak.

This idea and new cookware FIG. 4, will add to a new method of cooking raw meats. The possibilities are great for this new design. It makes cooking faster and easier, and with a lot less work and constant attention.

1) The Microwave Meat Cooker as seen in the abstract sheet FIGS. 1, 2, and 3 has a total of four parts.

2) The container FIG. 3 on the abstract sheet is the main part.

3) The container shown in FIG. 3 in the abstract sheet shows three vents on top one another shown at point 6. There are three sets of vents.

4) The closure of claim 1 wherein said are all composed of clear tempered plastic.

5) The closure of claim 1 wherein said has two levels that designed shaped like petree dish, shown in FIG. 2.

6) The closure of claim 2 wherein said has three level supports running vertically along the inside of the cookware, as seen in FIG. 3 point 6 on the abstract sheet.

7) The closure claim 3 wherein said are the vents which prevent pressure build up during the microwaving process.

8) The closure claim 5 wherein said the levels, shown on abstract sheet FIG. 2, are placed inside the cookware, seen in FIG. 3 in the abstract sheet, on the level supports point 6, FIG. 3, abstract sheet.

9) The closure claim 1 wherein said the lid has five slits as vents shown in FIG. 1 point 2.

10) The closure claim 9 thereof the vents prevent pressure build up.

11) the closure claim 1 wherein said is for microwave use only.

12) The closure claim 1 wherein said is a new cooking utility designed for the microwave. Its easier and a faster way of cooking raw meats and other food products that are microwaveable.
